(19) United States
(12) Patent Application Publication
(10) Pub. No.: US 2016/0211495 A1
(43) Pub. Date: Jul. 21, 2016

(54) FIRE GUARDS AND MATERIALS THEREFOR

(71) Applicant: WILLIAMS GRAND PRIX ENGINEERING LIMITED, Oxfordshire (GB)

(72) Inventors: EDWARD WATSON HAYNES, OXFORDSHIRE (GB); STEVE WISE, OXFORDSHIRE (GB); ANDREW JOHN GORTON, OXFORDSHIRE (GB)

(73) Assignee: WILLIAMS GRAND PRIX ENGINEERING LIMITED, Oxfordshire (GB)

(21) Appl. No.: 14/600,053

(22) Filed: Jan. 20, 2015

(51) Int. Cl. H01M 2/10; H01M 2/12; B32B 7/12; B32B 3/12; B32B 18/00; B32B 9/00

(52) U.S. Cl. CPC H01M 2/1083; B32B 18/00; B32B 9/007; B32B 7/12; B32B 3/12; H01M 2/1241; B32B 2255/26; B32B 2307/3065; B32B 2457/10; H01M 2220/20

(57) ABSTRACT

A motor land vehicle (10) includes a fire-guarded battery pack chamber (12) containing a battery system (22), the chamber having a relief port (34) with a bust disk (36), the chamber having a fire guard including a sheet of material comprising a first protective material which is ceramic and a second protective layer which is a carbon material.

The invention relates to multi-laminar materials for the containment of heat and/or flame, fire guards incorporating such materials and apparatus such as vehicles which incorporate such fire guards.

Some known batteries can malfunction, for example by catching fire if overcharged. This can not only be a problem in itself but can be even more problematic when such batteries are located near to combustible material where there is scope for fire to spread to the combustible material.

The present invention aims to alleviate at least to a certain extent the problems of the prior art.

According to a first aspect of the present invention there is provided a multi-laminar material for the containment of heat and/or flame, the material comprising:

a first protective layer comprising a ceramic material; and

a second protective layer comprising carbon material.

In some embodiments, the first protective layer comprises an alumina, silica or aluminosilicate ceramic material. The ceramic material preferably comprises one or more layers of a ceramic paper. In a preferred embodiment, the first protective layer comprises one or more, preferably two, sheets of alumina fibre paper. The layer of ceramic material preferably has a thickness of about 2-10 mm, preferably about 2-5 mm.

In some embodiments, the second protective layer comprises a carbon material which may be a carbon felt or may be provided as a foam or a honeycomb structure. Preferably, the carbon material is a pre-oxidised polyacrylonitrile (PAN) carbon material. Preferably, the second protective layer comprises a carbon felt.

In some embodiments, the second protective layer has a thickness of about 1-5 mm, preferably about 1-4 mm.

In some embodiments, the multi-laminar material further comprises a structural layer, preferably located adjacent the first protective layer. The structural layer may be formed from any solid material, for example comprising polymeric material, metal, metal alloy or any mixture thereof.

In some embodiments, the structural layer is formed by a core material and a coating (such as a panel comprising a core material and a coating). The coating preferably comprises a thermoset resin. The thermoset resin coating may comprise carbon fibre reinforcement. The thermoset resin may be an epoxy- or phenolic-resin, preferably an epoxy resin, preferably with carbon fibre reinforcement. The core material may comprise a metal or metal alloy, such as an aluminium alloy (preferably a 5000 series aluminium alloy). In an alternative embodiment, the core material comprises an aramid polymeric material, preferably a meta-aramid. In certain embodiments, the core comprises a meta-aramid polymer, preferably poly(m-phenylene isophthalamide). The aramid, metal or metal alloy material is preferably provided as sheets, arranged to form a cellular structure, preferably where the cellular structure is in a honeycomb configuration. The structural layer preferably has a sandwich structure, with core material sandwiched between coating.

In some embodiments, the thickness of the structural layer is about 5-12 mm, preferably about 6-9 mm.

In the preferred multi-laminar material, the first protective layer is positioned adjacent the second protective layer. In a preferred embodiment, where a structural layer is present, the first protective layer may be positioned between the structural layer and the second protective layer. In some embodiments, sealant and/or adhesive may be present between any of the structural, first protective and second protective layers, or external thereto.

In some embodiments, the ratio of the thicknesses of first protective layer:second protective layer is 2:1 to 1:1. In some embodiments, the ratio of thickness of structural layer:first protective layer:second protective layer is 6-3:2-1:1.

A further aspect of the invention provides a fire guard which includes a sheet of material in accordance with the above aspect of the invention.

A further aspect of the invention provides a fire-guarded chamber which includes a battery pack located in a chamber thereof, the chamber including a fire guard as in the previous aspect hereof.

At least a top wall of the chamber may be formed of the sheet of material.

The chamber may be sealed or substantially sealed.

The fire-guarded chamber may include a port arranged to open from the chamber to an exterior space upon application of a predetermined pressure at the port, the port being located on an underside of the chamber, the port preferably comprising a burst disk.

A further aspect of the invention provides a fire-guarded chamber which contains a battery pack and includes a port arranged to open from the chamber to an exterior space upon application of a predetermined pressure to the port, the port being located on an underside of the chamber, the port preferably comprising a burst disk.

A further aspect of the invention provides apparatus including a fire-guarded chamber as in any of the aspects hereof set out above and a tank arranged to contain a combustible fuel.

The tank may be located adjacent or above the fire-guarded chamber.

The apparatus may comprise a motor vehicle, such as a motor land vehicle. Application in other environments such as UPS systems, aircraft or spacecraft is also envisaged.

The battery pack may comprise a traction battery pack of the motor vehicle.

The traction battery pack may be arranged to supply electrical energy to (and/or receive power from) a powertrain motor (or generator) of the motor vehicle.

The generator is operable to supply electrical energy for charging the battery pack upon transmission of a signal indicative of a braking command issued within the vehicle.

The present invention may be carried out in various ways and preferred materials and apparatus in accordance with the invention will now be described by way of example only and with reference to the accompanying drawings, in which:

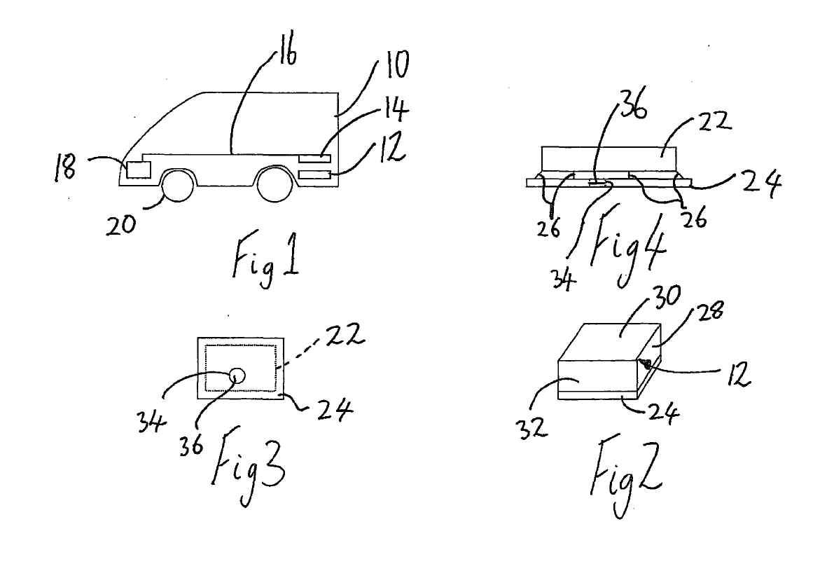

FIG. 1 is a schematic view of a motor vehicle which includes a preferred fire-guarded battery pack chamber using preferred multi-laminar material in accordance with a preferred embodiment;

FIG. 2 is a schematic view of the battery pack chamber;

FIG. 3 is a view of the battery pack chamber from underneath; and

FIG. 4 is a view of the battery pack chamber with a lid thereof removed.

There now follows a non-limiting detailed discussion.

A ‘ceramic material’ as referred to herein is an inorganic crystalline material. It should be appreciated that where the ceramic material is an alumina, silica or aluminosilicate ceramic, other components may also be present within the ceramic crystalline structure. Thus, in an alumina ceramic, alumina is the predominant oxide present, but other oxides including silica may also be present.

A ‘ceramic paper’ as referred to herein is a type of ceramic material in the form of a flexible sheet comprising ceramic fibres and optionally a binder. The ceramic fibres should be refractory any may, for example, be refractory alumina fibres.

Carbon fibres may be derived from polyacrylonitrile (PAN). A “pre-oxidized polyacrylonitrile carbon material” is a material formed from pre-oxidized PAN carbon fibres which may optionally have undergone further processing, for example to form a felt. The pre-oxidized material may undergo oxidation or may, preferably, be present in a pre-oxidised form.

A ‘carbon felt’ as referred to herein is a non-woven, carbon-containing fabric, which may be formed by compression of carbon fibres. A carbon felt is preferably formed from pre-oxidized polyacrylonitrile (PAN) carbon material. This may be referred to as a pre-oxidized PAN carbon felt.

An ‘aluminium alloy’ as referred to herein is an alloy in which aluminium is present, preferably as the predominant metal (by weight). Other elements present may include, for example, Cu, Mg, Mn, Si and Zn. An aluminium alloy as used herein is preferably an aluminium magnesium alloy, for example, a 5000 series aluminium alloy.

An ‘aramid’ as referred to herein is an aromatic polyamide. An aramid is preferably an aromatic polyamide in which at least least 85% of the amide linkages are attached directly to two aromatic rings.

A ‘honeycomb’ structure or configuration comprises an array of hollow cells formed between walls. The cells are generally hexagonal in shape.

### EXAMPLES

### Test Procedure

The test procedure used to assess the suitability of the multi-laminar material for use in a containment system for a lithium-ion battery was based on FAA Advisory Circular 20-135: POWERPLANT INSTALLATION AND PROPULSION SYSTEM COMPONENT FIRE PROTECTION TEST METHODS, STANDARDS, AND CRITERIA.

A test material was mounted with a gas flame to impinge directly on to the test material surface at a distance of approximately 20 mm. The temperature achieved in the test set-up was between 980° C. and 1020° C., using a Propane gas cylinder. For the purposes of comparative testing, a 1000° C. flame temperature was the target.

A propane gas torch was set at a short distance from the face of the test material. A thermocouple set in front of the test material surface measured the “flame” temperature. On the other side of the panel a thermocouple was bonded in a central position with tape. The two temperatures were monitored throughout the test using the Fluke multimeter. Fine gas adjustments were made to maintain flame maximum temperature. In general, initial flame temperatures were approximately 960° C., climbing to 1020° C. after ten or more minutes.

The requirements for a material suitable for use in a containment system of the invention are that the material has minimal thickness, minimal weight, is capable of resisting a flame with temperature 1000° C. directly on the surface for 15 minutes or more, while maintaining structural integrity, and providing sufficient thermal insulation to protect a fuel container which may be positioned in a vehicle adjacent the containment system.

The multi-laminar material of the invention was found to perform remarkably well and meet the above criteria, in contrast to a large number of other combinations of materials which were not able to satisfy the above requirements.

Materials tested for the protective layers included pre-oxidised PAN carbon felt, titanium alloy foil, silica aerogel, ceramic sheets, polyimide foam (Solimide®), refractory alumina fibre paper (Kaowool 1600 Paper), and alumina-boria-silica fibre fabric (Nextel® 312), in various combinations as shown in Table 1. Various sandwich panel materials were tested for the structural layer. Panel core materials included Nomex (poly(m-phenylene isophthalamide)), aluminium alloy, and a ceramic board (Cotronics 360-1).

TABLE 1
Material combinations tested and test summary. The
inner face is that closest to the gas flame.

| | | Test end | Test end | | Condition of |
|---|---|---|---|---|---|
| | | inner face | outer face | Duration | outer face, |
| Test | Material | temperature | temperature | of test | where not |
| No | Combination | (° C.) | (° C.) | (minutes) | satisfactory |
| 01 | Nomex + Ti + | 1050 | 243 | 6 | |
| | C-felt x1 | | | | |
| 02 | Nomex + | 985 | 309 | 6 | |
| | C-felt x1 | | | | |
| 03 | Nomex + Ti + | 1000 | 250 | 15 | Blistered |
| | C-felt x1 | | | | |
| 04 | Nomex + C-felt | 972 | 286 | 6 | Flames from |
| | x1 + Ti | | | | edges. |
| 05 | Ceramic + Ti + | 1026 | 230 | 15 | |
| | C-felt x1 | | | | |
| 06 | Ceramic + | 1008 | 266 | 15 | |
| | C-felt x1 | | | | |
| 07 | Ceramic + | 1016 | 214/230/220 | 15/28/40 | |
| | C-felt x2 | | | | |
| 08 | Ceramic + | 973 | 276 | 9.5 | Aerogel |
| | Aerogel | | | | degraded |
| 09 | Al-core + | 999 | 254 | 16 | |
| | C-Felt x2 | | | | |
| 10 | Nomex + | 1020 | 274/218 | 15/25 | Fuel bag |
| | C-felt x2 (with | | | | material |
| | fuel bag | | | | degraded |
| | material attached | | | | |
| | to outer face) | | | | |
| 11 | Nomex + | 1008 | 282 | 15 | Ceramic sheet |
| | Ceramic sheet | | | | degraded |
| 12 | Nomex+ | 1033 | 189/197 | 16/30 | |
| | Ceramic + | | | | |
| | x1 C-felt | | | | |
| 13 | Nomex + | 1007 | 258 | 15 | Seam intact, |
| | Ceramic | | | | but very weak |
| | (machined to | | | | |
| | 3 mm) + x1 | | | | |
| | C-felt | | | | |
| | (stitched seam) | | | | |
| 14 | Al-core + | 1040 | 206 | 15 | |
| | Ceramic + x1 | | | | |
| | C-felt | | | | |
| | (stitched seam) | | | | |
| 15 | Nomex + 3 mm | 1031 | 226 | 15 | |
| | Kaowool + | | | | |
| | C-felt | | | | |
| 16 | Nomex + 3 mm | 1041 | 232 | 15 | |
| | Kaowool + | | | | |
| | Panther felt | | | | |
| | with glass | | | | |
| 17 | Nomex + | 1025 | 252 | 15 | |
| | Kaowool FP + | | | | |
| | C-felt + Nextel | | | | |
| | 312 AF10 | | | | |
| 18 | Nomex panel + | 1042 | 264 | 15 | Evonik PI |
| | Evonik + | | | | foam degraded - |
| | C-felt + | | | | stuck to |
| | Nextel (used) | | | | CFRP panel |

The pre-oxidised PAN non-woven carbon felt was demonstrated to provide a superior flame barrier. In the most severe test, the felt suffered only minor degradation after 40 minutes of direct flame impingement with temperatures in excess of 1000° C. The titanium alloy foil performed badly when used as a direct flame barrier. Significant distortion and discolouration was observed, and the heat protection provided for the CFR-epoxy sandwich panel behind it was very poor. Ceramic sheet (Cotronics 360-1) was intact after 15 minutes exposure with direct flame impingement on the surface, but the top layers were significantly degraded. The results shown in Table 1 indicate that a ceramic and carbon felt combination provides advantageous protective properties in comparison to other materials.

A multi-laminar material taken forward to testing in a full scale test battery containment box comprised a combination of two layers of 1.4 mm thick Kaowool 1600 ceramic paper (88% alumina, 9% silica, 3% other oxides) and one layer of pre-oxidized PAN non-woven carbon felt at nominal thickness 1.8 mm. A structural layer was provided comprising a sandwich panel with an aluminium alloy (5052 alloy) honeycomb core (6.525 mm thick) and carbon-fibre reinforced epoxy matrix skins each side (0.6 mm thick each). An aluminium alloy was used in the tested material because of its higher strength as shown in stress analysis. For some applications, alternative core materials could be used. For example, an alternative and lighter core material is a Nomex® honeycomb core.

In testing of the test battery containment box, following ignition of Lithium ion battery cells, the fire was allowed to bum until exhaustion. The external temperature did not exceed 50° C. When disassembled, the structural integrity of the multilaminar material had not been compromised. It was concluded that this combination of materials is suitable for containment of a lithium ion battery.

The advantageous preferred materials described herein may advantageously be incorporated in a containment system to give fire resistance in the event of battery ignition, due to over-charging, or some other malfunction. Such containment systems have thus advantageously been found to be capable of limiting the spread of both flames and heat for a period of 15 minutes or more.

FIG. 1 shows an example of a motor land vehicle 10 in accordance with one embodiment, the vehicle including a fire-guarded battery pack chamber 12 located below a fuel tank 14 for supplying combustible liquid or gaseous fuel via a fuel line 16 to a combustion engine 18 (such as an IC engine) for supplying tractive power to at least one ground drive wheel 20 of the motor land vehicle 10.

The battery pack chamber 12 contains a Lithium-based (e.g. Lithium-ion) traction battery system 22 which is arranged to power the vehicle along by tractive electric motor power together with or as an alternate power source to the engine 18, the traction battery system also being chargeable in a conventional manner such as by a generator (not shown) of the vehicle 10, e.g. driven from the engine 18 and/or by regenerative braking functionality, the generator in one example being reconfigurable as an electric motor to provide the tractive electric motor power mentioned above.

As shown in FIG. 4, the battery system 22 is secured to a rectangular base 24 of the chamber 12 by supports 26. The chamber 12 also has a lid 28 which has a rectangular top surface 30 and four rectangular sides 32 (two of which are shown in FIG. 2), the four sides 32, lid 28 and base 24 forming a sealed or substantially sealed enclosure containing the battery system 22 when the lid 28 is secured down onto the base 24.

At least the top surface 30 of the lid 28 and preferably also at least parts of and typically all of the sides 32 of the lid 28 are made from multi-laminar material comprising a carbon fibre reinforced-epoxy skinned sandwich panel with an aluminium alloy honeycomb core, plus two sheets of alumina fibre ceramic paper, supplemented with one layer of pre-oxidised PAN non-woven carbon felt, with the ceramic paper and carbon felt held in place with a covering comprising a one ply aramid-epoxy composite fabric. Optionally, the base 24 is also made of this material.

The base 24 incorporates a relief port in the form of a circular aperture 34 formed therethrough and positioned below the battery system 22, a circular burst disk 36 being located within the circular aperture 34.

In the event of a malfunction of the battery system, such as overcharging, resulting in fire there is firstly a limited amount of oxygen available to feed the fire. In the event of continued fire and a pressure build-up within the chamber 12, the relief port 34, 36 may advantageously open at a predetermined pressure by means of bursting of the burst disk 36. Accordingly, a catastrophic pressure build is advantageously avoided so that the chamber 12 cannot explode or otherwise release pressure in an uncontrolled manner. Furthermore, the relatively small burst aperture 34 may allow a flow of fire combustion products out of the chamber 12 while restricting the counterflow of oxygen-containing air into the chamber 12. Furthermore, the combustion products are advantageously ejected downwardly out of the chamber and away from the fuel tank 14.

Furthermore, while the fire is burning and if it continues to do so, the preferred laminate material used in the construction of the chamber 12 provides excellent flame guarding and thermal transfer restriction performance for a continued period which may exceed 15 minutes. Even with the fuel tank 14 containing combustible fuel and positioned near to, next to or above the chamber 12, the excellent performance of the chamber 12 helps ensure that fire and/or heat do not easily cause fire to break out at or in the region of the fuel tank or elsewhere in the motor land vehicle 10.

It is envisaged that in other embodiments a plurality of similar relief ports 34, 36 may be provided through the base 24 of the chamber 12.

Various modifications to the specifically described examples are envisaged and are considered to fall within the scope of the present invention as defined by the accompanying claims as interpreted under patent law.

1. A fire-guarded chamber as claimed in claim 36, wherein said chamber comprises a fire guard which comprises a multi-laminar material for the containment of heat and/or flame, said material comprising:
a first protective layer comprising a ceramic material; and
a second protective layer comprising carbon material.

2. A fire-guarded chamber as claimed in claim 1 in which said first protective layer comprises an alumina, silica or aluminosilicate ceramic material.

3. A fire-guarded chamber as claimed in claim 1 in which said ceramic material comprises one or more layers of ceramic paper.

4. A fire-guarded chamber as claimed in claim 1, wherein said first protective layer comprises one or more layers of alumina fibre paper.

5. A fire-guarded chamber as claimed in claim 1, in which the layer of ceramic material has a thickness within the range of 2-10 mm, and preferably within the range of 2-5 mm.

6. A fire-guarded chamber as claimed in claim 1 in which said second protective layer comprises a carbon felt.

7. A fire-guarded chamber as claimed in claim 1 in which said carbon material is a pre-oxidized polyacrylonitrile carbon material.

8. A fire-guarded chamber as claimed in claim 1 in which said second protective layer has a thickness within the range of 1-5 mm.

9. A fire-guarded chamber as claimed in claim 1, wherein said material further comprises a structural layer.

10. A fire-guarded chamber as claimed in claim 9 in which said structural layer is formed by a panel comprising a core material and a coating.

11. A fire-guarded material as claimed in claim 10, in which said coating comprises a thermoset resin.

12. A fire-guarded chamber as claimed in claim 10, wherein said coating comprises a carbon fiber reinforcement.

13. A fire-guarded chamber as claimed in claim 10, in which said thermoset resin is an epoxy or phenolic resin.

14. A fire-guarded chamber as claimed in claim 10 in which siad core material comprises a metal alloy, a metal, an aramid polymeric material, or a mixture thereof.

15. A fire-guarded material as claimed in claim 10 in which said core material comprises an aluminum alloy.

16. A fire-guarded chamber as claimed in claim 10 in which said core material is provided as sheets, arranged so as to form a cellular structure.

17. A fire-guarded chamber as claimed in claim 9, in which the thickness of said structural layer is within the range of 5-12 mm.

18. A fire-guarded chamber as claimed in claim 1 in which the ratio of the thicknesses of said first protective layer to said second protective layer is within the range of 2:1 to 1:1.

19. A fire-guarded chamber as claimed in claim 9 in which said first protective layer is positioned between said structural layer and said second protective layer.

20. A fire-guarded chamber as claimed in any claim 9 in which sealant and/or adhesive layers are present between any of said structural, said first protective layer, and said second protective layers, or external thereto.

21. (canceled)

22. (canceled)

23. A fire-guarded chamber as claimed in claim 36 in which at least a top wall of said chamber is formed of a sheet of material.

24. (canceled)

25. A fire-guarded chamber as claimed in claim 36, wherein said port is located on an underside of said chamber.

26. (canceled)

27. A fire-guarded chamber as claimed in claim 36, further comprising a tank arranged to contain a combustible fuel.

28. A fire guarded chamber as claimed in claim 27 in which said tank is located adjacent to, or above, said fire-guarded chamber.

29. A fire-guarded chamber as claimed in claim 27 wherein said fire-guarded chamber comprises a component of a motor vehicle.

30. A fire-guarded chamber as claimed in claim 29 in which said battery pack comprises a traction battery pack of said motor vehicle.

31. A fire-guarded chamber as claimed in claim 30 in which said traction battery pack supplies electrical energy to, and/or receives power from, a powertrain motor or generator of said motor vehicle.

32. A fire-guarded chamber as claimed in claim 31 in which said generator is operable to supply electrical energy for charging said battery pack upon transmission of a signal indicative of a braking command issued within said motor vehicle.

33. (canceled)

34. (canceled)

35. (canceled)

36. A fire-guarded chamber which contains a battery pack, wherein:
said chamber is substantially sealed and includes a port arranged to open from said chamber to an exterior space upon application of a predetermined pressure force exerted upon said port.

37. A fire-guarded chamber as claimed in claim 5, wherein said layer of ceramic material has a thickness which is within the range of 2-5 mm.

38. A fire-guarded chamber as claimed in claim 8 in which said second protective layer has a thickness within the range of 1-4 mm.

39. A fire-guarded chamber as claimed in claim 13 in which said thermoset resin has a carbon fiber reinforcement.

40. A fire-guarded material as claimed in claim 16 in which said cellular structure has a honeycomb configuration.

41. A fire-guarded chamber as claimed in claim 17, in which the thickness of said structural layer is within the range of 6-9 mm.

42. A fire-guarded chamber as claimed in claim 36, wherein said port comprises a burst disk.
